(19) United States
(12) Patent Application Publication
(10) Pub. No.: US 2009/0182249 A1
(43) Pub. Date: Jul. 16, 2009

(54) MASSAGING DEVICE

(75) Inventors: Hiroei Sakai, Tsubame-shi (JP); Masahiro Kobayashi, Tsubame-shi (JP); Katsuhiko Yoshida, Tsubame-shi (JP)

Correspondence Address: DARBY & DARBY P.C., P.O. BOX 770, Church Street Station, New York, NY, 10008-0770, US

(73) Assignee: Twinbird Corporation, Tsubame-shi (JP)

(21) Appl. No.: 12/332,791

(22) Filed: Dec. 11, 2008

(30) Foreign Application Priority Data
Jan. 16, 2008 (JP) 2008-007421

(51) Int. Cl. A61H 7/00

(52) U.S. Cl. 601/136; 601/137; 601/134

(57) ABSTRACT

In a massaging device, a treating section 3 has a body plate 4 formed of a flexible material and a plurality of protrusions intersecting the surface of the body plate and protruding downwardly. A massaging device main body has a reciprocal drive mechanism that deflects the body plate up and down. The small wall-like protrusions smaller than the third protrusions are provided on the surface of the body plate, and communicating portions communicating the interior with the exterior are provided inside the small wall-like protrusions. A containing portion for shampoo that is communicated with the communicating portions is provided between the massaging device main body and the body plate. A shampoo is applied inside the small wall-like protrusions with the surface of the body plate facing upwardly, and is supplied to the containing portion. The shampoo is whipped correspondingly to the deflection of the body plate while supplied from the communicating portions to perform hair washing and scalp massaging.

### CROSS-REFERENCE TO RELATED APPLICATION

This application claims the benefit under 35 U.S.C § 119 of Japanese Patent Application No. 2008-007421, filed on Jan. 16, 2008, which is hereby incorporated by reference in its entirety.

### BACKGROUND OF THE INVENTION

1. Field of the Invention

The present invention relates to a power-driven massaging device, and more particularly, a massaging device which can be used for scalp massaging, kneading-style washing and the like in hair washing.

2. Description of the Related Art

Conventionally, as disclosed in Unexamined Japanese Patent Application Laid-open Publication No. 2007-229159, there is known a massaging device of the foregoing type that comprises a drive section and a treating section driven by the drive section. The drive section is provided with a frame that detachably holds the peripheral edge of a body plate of the treating section with a positional relationship relative to the drive section being fixed, and is further provided with a reciprocal drive mechanism that deflects the body plate in a direction intersecting with the surface of the body plate. The treating section comprises the body plate that is formed of a flexible material, and a plurality of protrusions protrudingly provided on the body plate. The massaging device causes the reciprocal drive mechanism to deflect the body plate of the treating section to repeatedly incline and raise the plurality of protrusions provided on the body plate in accordance with the deflection of the body plate, so that the plurality of protrusions open and close relative to one another, thereby massaging a scalp in various ways like kneading, rubbing, knocking, and the like by the opening/closing of the protrusions. As shown in FIGS. 6 and 7, the massaging device enables massaging of a scalp S by movement of plural kinds of protrusions 104, 105, and 106 in accordance with the deflection of a body plate 103 of a treating section 102 driven by a drive section 101 when the body plate 103, which is positioned in the treating section 102 driven by the drive section 101, repeats deformation between a downwardly deflected curved convex condition and an upwardly deflected curved concave condition, as if the protrusions 104, 105 and 106 function like fingers.

In performing hair washing or scalp massaging, however, it is necessary for a user to apply lightly whipped shampoo to hair or a scalp in order to wash the hair or the scalp or to suppress any damaging of the hair by friction, and then to push the treating section against the scalp, holding the massaging device. Accordingly, it needs some work to use the massaging device. Moreover, in whipping a shampoo, it is difficult to finely whip the shampoo by hands, resulting in insufficient washing of the hair and the scalp and insufficient protection for the hair against friction. Further, if the massaging device is held by a slippery hand which has applied the shampoo to the hair, there is a possibility that the massaging device is dropped and damaged, and the user gets hurt in the worst occasion. The same is true on a case where the user performs massaging using a hair growth tonic or the like.

Further, the user may put an appropriate amount of liquid, such as a shampoo or a hair growth tonic, on the surface of the body plate of the treating section and then push the treating section on which the shampoo or the hair growth tonic is put against a scalp to perform hair washing or massaging. In this case, however, there is a possibility that the shampoo or the hair growth tonic runs down from the treating section and adheres to the drive section. When the user holds the drive section to which the shampoo or the hair growth tonic adheres, the massaging device may be dropped and damaged, and the user may get hurt in the worst occasion.

The present invention has been made to overcome the foregoing problems, and it is an object of the present invention to provide a massaging device that enables hair washing and scalp massaging easily, effectively, and surely.

### SUMMARY OF THE INVENTION

To achieve the object, a massaging device according to the first aspect of the present invention includes:

a drive section;

a treating section driven by the drive section, having a body plate formed of a flexible material and a plurality of protrusions protrudingly provided on a surface of the body plate, wherein a peripheral edge of the body plate is held by the drive section with a positional relationship to the drive section being fixed; and

a reciprocal drive mechanism that deflects the body plate in a direction intersecting with the surface of the body plate, and wherein

small wall-like protrusions each having a protrusive length from the surface of the body plate smaller than each of the plural protrusions are successively provided on the surface of the body plate.

According to the present invention, a portion inside the small wall-like protrusions may be blocked out from other portions.

According to the present invention, the small wall-like protrusions may be circularly provided on a plane.

According to the present invention, a communicating portion that communicates an interior and an exterior of a region surrounded by the drive section and the treating section may be provided at the body plate or each of the plural protrusions, and a containing portion for a liquid like shampoo which is communicated with the communicating portion may be further provided.

According to the present invention, the containing portion may operate correspondingly to deflection of the body plate.

According to the present invention, the containing portion may be formed of a synthetic sponge, such as an interconnected type foamed polyurethane or a foamed rubber, or a marine sponge (natural sponge).

According to the present invention, the small wall-like protrusions provided on the surface of the body plate may surround the communicating portion.

According to the present invention, a plurality of communicating portions may be circularly provided along a circle with predetermined intervals.

According to the present invention, the small wall-like protrusions circularly provided may connect the adjoining protrusions.

According to the present invention, the drive section may have a frame that detachably holds the peripheral edge of the body plate with the positional relationship of the body plate relative to the drive section being fixed.

### BRIEF DESCRIPTION OF THE DRAWINGS

FIG. 1 is a perspective view showing an embodiment of the present invention;

FIG. 2 is a cross-sectional view showing the embodiment of the present invention;

FIG. 3 is a perspective view showing a treating section according to the embodiment of the present invention;

FIG. 4 is a cross-sectional view showing the treating section according to the embodiment of the present invention;

FIG. 5 is a diagram showing the bottom face of the treating section according to the first embodiment of the present invention;

FIG. 6 is a cross-sectional view showing a conventional example with a body plate being in a curved convex condition; and

FIG. 7 is a cross-sectional view showing the conventional example with the body plate being in a curved concave condition.

### DETAILED DESCRIPTION OF THE PREFERRED EMBODIMENTS

Preferred embodiments of the present invention will be explained with reference to the accompanying drawings. The embodiments to be explained below shall not limit the scope of the present invention described in claims, and all of the structural components explained below shall not be always essential requirements to carry out the present invention.

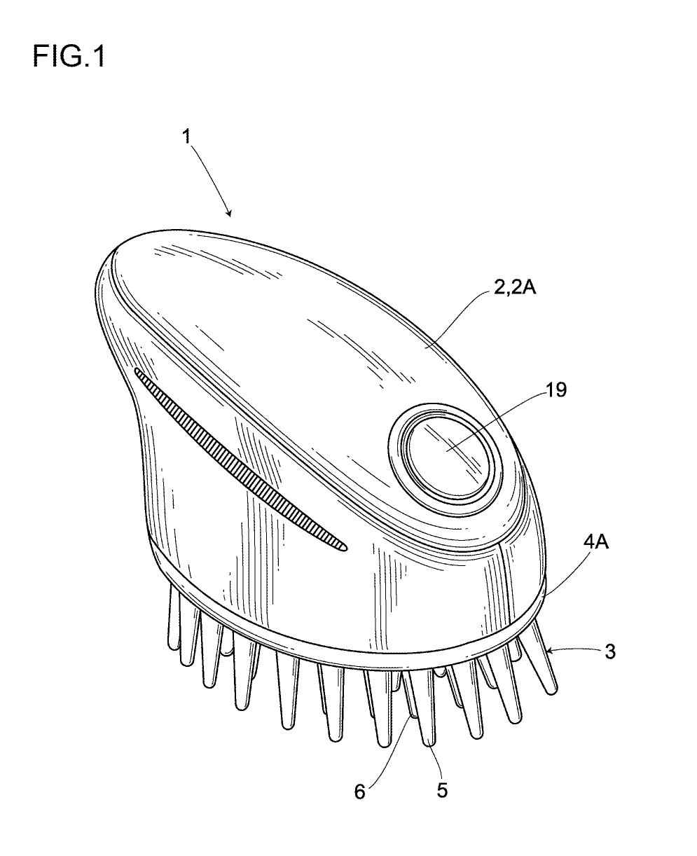

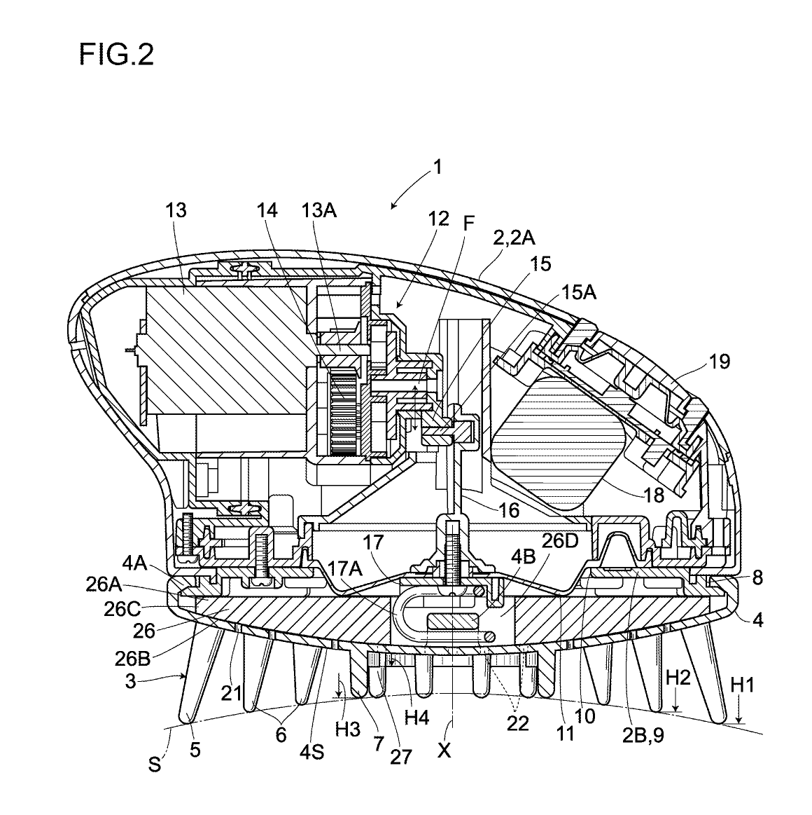

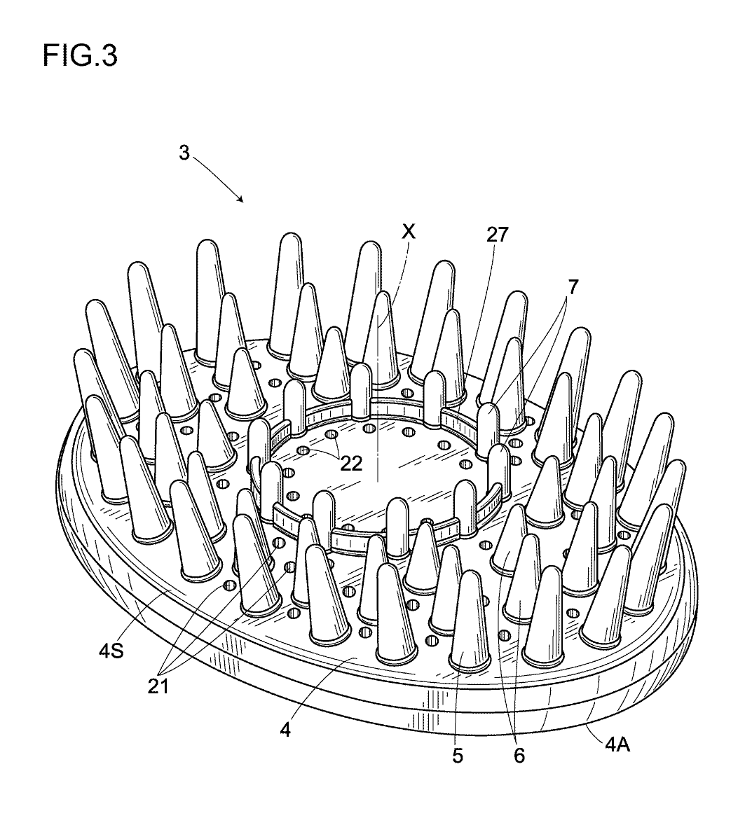

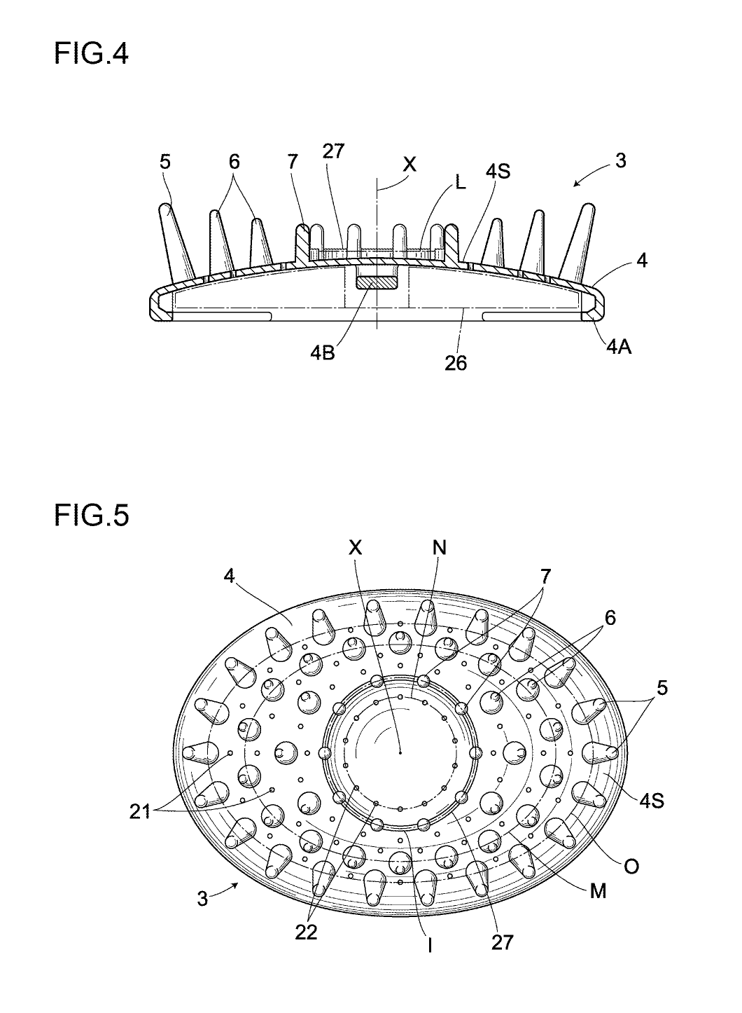

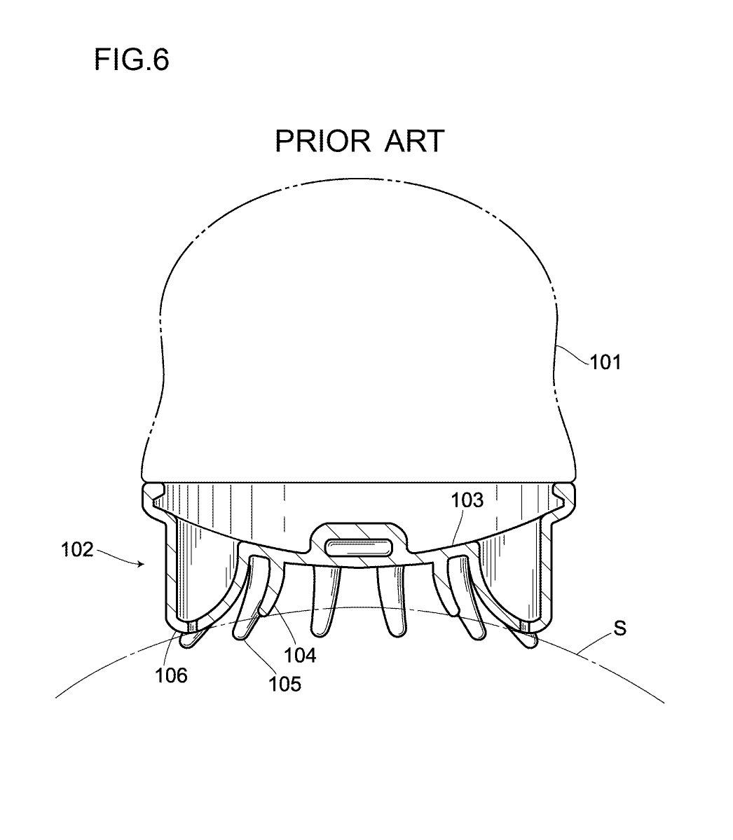

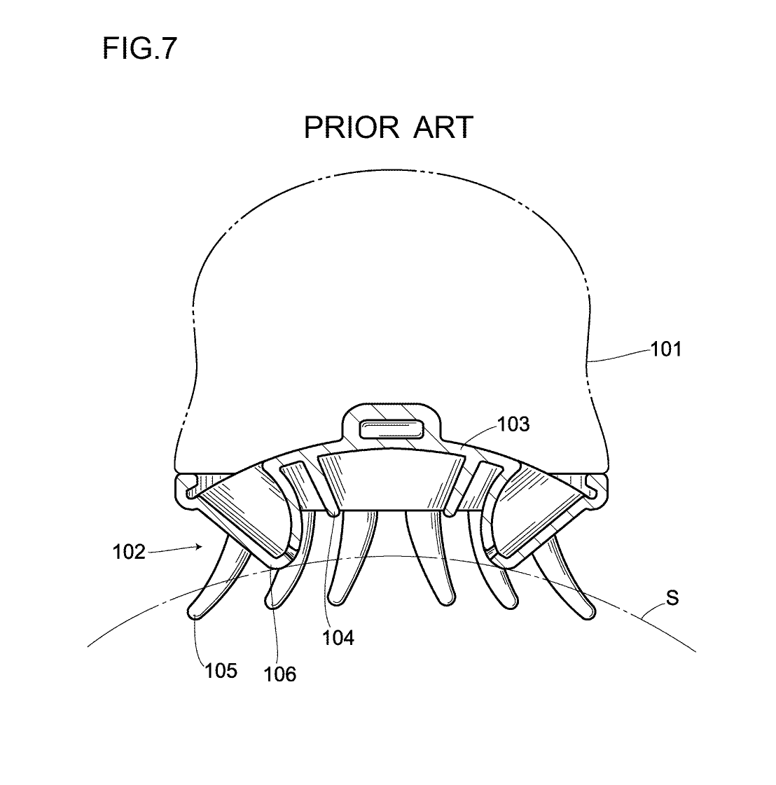

FIGS. 1 to 5 show the embodiment. In the embodiment, the vertical direction is defined with reference to a posture shown in FIG. 2. Reference numeral 1 denotes a massaging device of the present invention. The massaging device 1 comprises a massaging device main body 2 functioning as a drive section, and a treating section 3 detachably attached to the bottom part of the massaging device main body 2. The treating section 3 comprises a body plate 4 and three kinds of protrusions 5, 6 and 7 formed integral with the body plate 4 in a manner protruding in a downward direction which is a direction intersecting the bottom face of the body plate 4. The body plate 4 is formed in an elliptical shape as viewed from the top, and is formed of elastomer having flexibility and elasticity. An edge 4A of the body plate 4 is fixed to the bottom edge of the massaging device main body 2. Note that word “fix” includes a connection allowing some movement, and in the embodiment, as the edge 4A of the body plate 4 is fit into a fixation frame 8 comprised of a groove formed along the bottom face of the massaging device main body 2, both sections are detachably connected to each other throughout the whole periphery.

The massaging device main body 2 comprises a case main body 2A having an opened bottom face and a size that a user can hold it by one hand, and a bottom face part 2B that closes the opened bottom face of the case main body 2A. The bottom face part 2B has a bottom plate 9 and a cover 11. The bottom plate 9 is formed in an elliptical shape as viewed from the top, has an outer periphery fixed to the bottom edge of the case main body 2A, and has a circular opening 10 formed at the center of the bottom plate 9 and passing throughout it in the vertical direction. The extensible cover 11 is provided in such a manner as to cover the opening 10. The cover 11 is formed of, for example, a rubber, a synthetic rubber, or elastomer having flexibility, and is an accordion-like film that covers the opening 10 water-tightly. The massaging device main body 2 has a reciprocal drive mechanism 12 thereinside that reciprocally moves the center of the body plate 4 up and down. The reciprocal drive mechanism 12 has a motor 13 as a drive source provided on the bottom plate 9, a crank mechanism 15 connected to a motor shaft 13A of the motor 13 through a speed reduction gear means 14, and a connecting rod 16 having one end connected to an eccentric shaft 15A of the crank mechanism 15. The cover 11 has a connection joint member 17 integrally attached to the approximate center thereof. The connection joint member 17 clamps and fixes the cover 11 in such a way that the cover 11 is clamped by the upper surface of the connection joint member 17 and the other side of the connecting rod 16, and has a hook 17A provided at the bottom surface thereof. The hook 17A is detachably connected to a hook receiving part 4B provided on the center of the upper face of the body plate 4. Accordingly, the connection joint member 17 reciprocally moves up and down as the rotational movement of the motor 13 is converted into a reciprocal movement by the crank mechanism 15 and the connecting rod 16. Thus, a portion where the hook receiving part 4B is provided becomes a maximum vibrating portion in the body plate 4, and the amplitude of vibration is twice (2F) as much as an eccentric distance (F) from the central axis of the crank mechanism 15 to the eccentric shaft 15A. A virtual central axis line X is formed in the vertical direction through the hook receiving part 4B and the connection joint member 17. Furthermore, the massaging device main body 2 has a battery 18 thereinside that supplies power to the motor 13, and a switch 19 for operating the motor 13 is provided on the upper face of the massaging device main body 2.

Next, an explanation will be given of the treating section 3. The first to third protrusions 5, 6 and 7 are each formed in a tapered frustoconical shape having a rounded distal end. The protrusions 5, 6 and 7 are provided along an elliptical virtual outer ring O disposed along an edge 4A of the body plate 4, an elliptical virtual middle ring M disposed inside the outer ring O, and a circular virtual inner ring I disposed inside the middle ring M, with respect to the virtual central axis line X passing through the approximate center of the body plate 4 in the vertical direction.

The body plate 4 is further provided with first communicating portion 21 and second communicating portion 22 each of which is defined by a plurality of small through-holes communicating the interior and exterior of a region surrounded by the massaging device main body 2 and the treating section 3. A containing portion 26 for a shampoo L which moves correspondingly to the deflection of the body plate 4 is provided in communication with the communicating portions 21, 22 in the foregoing region. That is, the containing portion 26 for the shampoo L is provided between the bottom face part 2B and the internal face of the body plate 4. The first communicating portion 21 is provided outside the virtual inner ring I. The second communicating portion 22 is disposed circularly with intervals along a virtual circular center ring N provided inside the virtual inner ring I with respect to the central axis line X.

The small wall-like protrusions 27 each of which connects adjoining third protrusions 7 are provided circularly on the virtual inner ring I. The small wall-like protrusions 27 are wall-like protrusions so disposed as to surround the second communicating portion 22, and a length H4 thereof from a surface 4S of the body plate 4 in the height direction is smaller than a length H3 of the third protrusion 4 in the height direction connected by the small wall-like protrusion 27. The circularly-provided small wall-like protrusions 27 partition the inner part of the small wall-like protrusions 27 from other parts. Let us suppose that the lengths of the first and second protrusions 5 and 6 in the height direction are H1, H2, respectively, such lengths are H1>H2>H3>H4.

The containing portion 26 repeats compression and restoration in accordance with the deflection of the body plate 4, thereby suctioning and discharging the shampoo L through the communicating portions 21, 22. Note that in the embodiment, the containing portion 26 is formed of an elastic body, such as a synthetic sponge like interconnected type foamed polyurethane or foamed rubber, or a marine sponge (natural sponge), and as shown in FIG. 2, when the body plate 4 is under the downwardly deflected curved convex condition, the containing portion 26 becomes a non-compression condition or slightly compressed condition, and stays between the bottom face part 2B and the upper face of the body plate 4. That is, when the body plate 4 is under the downwardly deflected curved convex condition, an upper face 26A of the containing portion 26 contacts or comes close to the bottom face part 2B, a bottom face 26B of the containing portion 26 contacts or comes close to the upper face of the body plate 4, and an outer periphery 26C of the containing portion 26 contacts or comes close to the frame 8. A through-hole 26D is formed at the center of the containing portion 26, i.e., along the central axis line X. The hook receiving part 4B and the hook 17 are connected together through the through-hole 26D.

Next, the effect of the foregoing structure will be explained. In performing massaging of a scalp S or kneading-style washing, first, a user supplies an appropriate amount of water in the containing portion 26 beforehand. Note that water is absorbed into the containing portion 26 through the communicating portions 21, 22 by soaking the massaging device 1 into water. An appropriate amount of shampoo L is applied to the internal part of the small wall-like protrusions 27 with the surface 4S of the body plate 4 facing upward. At this time, the shampoo L applied inside the small wall-like protrusions 27 on the body plate 4 does not flow out from the small wall-like protrusions 27 unless the shampoo L is applied too much. A small amount of shampoo L is absorbed into the containing portion 26 through the second communicating portion 22.

Next, as the switch 19 is operated, power is supplied from the battery 18, so that the motor 13 starts operating, and the motor shaft 13A rotates. According to this rotation, the crank mechanism 15 connected to the motor shaft 13A through the speed reduction gear means 14 rotates, and the crank mechanism 15 and the connecting rod 16 connected to the eccentric shaft 15A of the crank mechanism 15 convert the rotational movement of the motor shaft 13A into a reciprocal movement, so that the connection joint member 17 jointed to the connecting rod 17 reciprocally moves up and down. The body plate 4 repeats deformation between a downwardly deflected curved convex condition and an upwardly deflected curved concave condition like the conventional technology in such a way that the hook receiving part 4B connected to the connection joint member 17, i.e., the center of the body plate 4 becomes the maximum vibrating portion. The amplitude of vibration at the maximum vibrating portion is twice (2F) as much as the eccentric distance F from the central axis of the crank mechanism 15 to the eccentric shaft 15A.

As explained above, as the body plate 4 repeats deformation between a downwardly deflected curved convex condition and an upwardly deflected curved concave condition, the space between the body plate 4 and the bottom face part 2B repeats compression and restoration. As a result, the containing portion 26 repeats compression and restoration in accordance with the deflection of the body plate 4. When the containing portion 26 is restored from the compressed condition, the space between the body plate 4 and the bottom face part 2B becomes a reduced-pressure condition, the shampoo L applied inside the circular small wall-like protrusions 27 is absorbed through the second communicating portion 22 and flows into the space, and is contained in the containing portion 26. Conversely, when the containing portion 26 is compressed, the shampoo L contained in the containing portion 26 is discharged through the second communicating portion 22. Note that the shampoo L is mixed with air, and is whipped when pushed out through the second communicating portion 22. As the deformation of the containing portion 26 is repeated in this fashion, the shampoo L gradually spreads from the center of the containing portion toward the outer periphery thereof, so that the shampoo L is pushed out from the first communicating portion 21. As the containing portion 26 repeats compression and restoration in accordance with the deformation of the body plate repeated between a curved convex condition and a curved concave condition in this fashion, the shampoo L applied inside the small wall-like protrusions 27 is whipped and supplied from the entire treating section 3 to the exterior. The shampoo L is finely whipped when passing through the communicating portions 21, 22. The smaller the diameters of the holes of the communicating portions 21, 22 are, the finer the shampoo L is whipped.

As explained above, with the shampoo L being whipped, the user grips and holds the massaging device main body 2, pushes the distal ends of the protrusions 5, 6 and 7 against a scalp S and maintain this condition with his/her hand. Mainly, as the first protrusions 5 repeat inclining inwardly and rising with respect to the central axis line X, massaging is carried out as if the scalp S is kneaded. Because the second protrusions 6 are shorter than the first protrusions 5, the second protrusions 6 repeat inclining inwardly and rising with respect to the central axis line X, and massaging is carried out in such a way that the leading ends of the second protrusions 6 are rubbed with the scalp S. Furthermore, as the third protrusions 7 repeat abutting and moving apart with respect to the scalp S by the deflection of the body plate 4, massaging is carried out in such a manner as to slightly knock the scalp S. Therefore, massaging is carried out using the protrusions 5, 6 and 7, and simultaneously, the scalp S and hair (not shown) are washed using the finely-whipped shampoo L. At this time, because the shampoo L whipped finer in comparison with a case where the user whips the shampoo L with his/her hands is used to perform hair washing and massaging, it is possible to effectively wash the hair and the scalp S, and it is also possible to protect the hair from friction with the treating section 3 formed of a material having a relatively-high friction coefficient like elastomer.

When hair washing and massaging of the scalp are performed using the massaging device 1 of the present invention, it is not necessary for the user to whip the shampoo L using his/her hands, but by activating the massaging device 1, the shampoo L applied inside the small wall-like protrusions 27 is absorbed into the containing portion 26, and then finely whipped when pushed out through the communicating portions 21, 22. This makes it possible for the user to easily perform hair washing and massaging, and because the foam of the shampoo L which reduces friction does not adhere to the hand of the user holding the massaging device main body 2, it is possible to prevent the user from dropping the massaging device 1 and breaking it.

As explained above, according to the massaging device 1 of the embodiment, the treating section 3 having a plurality of protrusions 5 to 7 provided on the flexible body plate 4 in such a manner as to intersect the surface of the body plate 4 is detachably held by the frame 8 of the massaging device main body 2 serving as a drive section and the reciprocal drive mechanism 12 inside the massaging device main body 2 with the positional relationship relative to the massaging device main body 2 being fixed. The reciprocal drive mechanism 12 repeatedly deflects the body plate 4 in a direction intersecting the surface 4S, thereby performing hair washing or massaging of the scalp S using the protrusions 5 to 7. Because the small wall-like protrusions 27 each having a protrusive length H4 smaller than the protrusive length H3 of the third protrusions 7 from the surface 4S are circularly provided on the surface 4S of the body plate 4, by applying the shampoo L inside the small wall-like protrusions 27 with the surface 4S facing up, the shampoo L does not flow out from the treating section 3 and does not adhere to the massaging device main body 2, so that the user's hand will not be slippery.

Moreover, because the body plate 4 has the second communicating portions 22 communicating the interior and exterior of a region surrounded by the massaging device main body 2 serving as the drive section and the treating section 3, and the containing portion 26 for the shampoo L which moves correspondingly to the deflection of the body plate 4 is provided in that region, by activating the massaging device 1, the shampoo L which is absorbed into the containing portion 26 from the inside of the small wall-like protrusions 27 through the second communicating portion 22 is pushed out from the communicating portions 21, 22 and whipped. This makes it possible for the user to easily perform hair washing and massaging, and because the shampoo L does not adhere to the hand of the user holding the massaging device main body 2, it is possible to reduce a possibility that the user slippery dropping the massaging device 1 from his/her hand.

The massaging device of the present invention is not limited to the foregoing embodiment, and can be changed and modified in various forms within the scope of the present invention. For example, in the foregoing embodiment, although the communicating portions are formed only in the body plate of the treating section, the communicating portions may be formed in the protrusions of the treating section. Moreover, in the foregoing embodiment, the small wall-like protrusions are formed at the center of the body plate, but may be formed at the outer periphery of the body plate. Further, in the foregoing embodiment, the small wall-like protrusions are formed in such a manner as to connect adjoining third protrusions, but may be provided independently from the third protrusions.

Alternatively, the small wall-like protrusion may be arranged annularly outside the circularly-provided second communicating portion 22 but inside the third protrusions 7 with respect to the central axis line X. Still alternatively, the small wall-like protrusion may be arranged annularly outside the circularly-provided third protrusions 7 but inside the second protrusions 6 with respect to the central axis line X.

What is claimed is:

1. A massaging device comprising:
a drive section;
a treating section driven by the drive section, having a body plate formed of a flexible material and a plurality of protrusions protrudingly provided on a surface of the body plate, wherein a peripheral edge of the body plate is held by the drive section with a positional relationship to the drive section being fixed; and
a reciprocal drive mechanism that deflects the body plate in a direction intersecting with the surface of the body plate, and wherein
small wall-like protrusions each having a protrusive length from the surface of the body plate smaller than each of the plural protrusions are successively provided on the surface of the body plate.

2. The massaging device according to claim 1, wherein inside portion of the small wall-like protrusions is blocked out from other portions.

3. The massaging device according to claim 2, wherein the small wall-like protrusions are circularly provided on a plane.

4. The massaging device according to claim 3, wherein a communicating portion that communicates an interior and an exterior of a region surrounded by the drive section and the treating section is provided at the body plate or each of the plurality of protrusions, and a containing portion for a liquid like shampoo which is communicated with the communicating portion is further provided.

5. The massaging device according to claim 4, wherein the containing portion operates correspondingly to the deflection of the body plate.

6. The massaging device according to claim 5, wherein the containing portion is formed of a synthetic sponge, such as an interconnected type foamed polyurethane or a foamed rubber, or a marine sponge (natural sponge).

7. The massaging device according to claim 6, wherein the small wall-like protrusions provided on the surface of the body plate surround the communicating portion.

8. The massaging device according to claim 7, wherein a plurality of communicating portions are circularly provided along a circle with predetermined intervals.

9. The massaging device according to claim 8, wherein the small wall-like protrusions circularly provided to connect the adjoining protrusions.

10. The massaging device according to claim 9, wherein the drive section has a frame that freely-detachably holds the peripheral edge of the body plate with the positional relationship of the body plate relative to the drive section being fixed.
